(19) United States
(12) Patent Application Publication
(10) Pub. No.: US 2007/0126663 A1
(43) Pub. Date: Jun. 7, 2007

(54) Pixel driving circuit with threshold voltage compensation circuit

(76) Inventors: Gyu Hyun Kim, Seo-gu (KR); Yil Suk Yang, Yuseong-gu (KR); Dae Woo Lee, Yuseong-gu (KR); Jong Dae Kim, Seo-gu (KR)

Correspondence Address: LADAS & PARRY LLP, 224 SOUTH MICHIGAN AVENUE, SUITE 1600, CHICAGO, IL, 60604, US

(21) Appl. No.: 11/521,338

(22) Filed: Sep. 14, 2006

(30) Foreign Application Priority Data
Dec. 7, 2005 (KR) 10-2005-0119056
Jun. 22, 2006 (KR) 10-2006-0056388

(51) Int. Cl. G09G 3/30

(52) U.S. Cl. 345/76

(57) ABSTRACT

Provided is a pixel driving circuit including a threshold voltage compensation circuit. The pixel driving circuit includes a diode-connected type first transistor through which input current data flows; a second transistor copying the current data flowing through the first transistor; a third transistor connected in series to the second transistor; a fourth transistor diode-connected between a power supply voltage terminal and the third transistor; and a driving transistor connected to the power supply voltage terminal, copying the current data flowing through the third transistor, and providing the data to a light emitting diode. Since the pixel driving circuit compensates for variation in the threshold voltage of the driving transistor driving each pixel, brightness uniformity of pixels according to applied current data can be maintained.

### CROSS-REFERENCE TO RELATED APPLICATION

This application claims priority to and the benefit of Korean Patent Application Nos. 2005-119056, filed Dec. 7, 2005, and 2006-56388, filed Jun. 22, 2006, the disclosures of which are incorporated herein by reference in their entirety.

### BACKGROUND

1. Field of the Invention

The present invention relates to a pixel driving circuit for driving pixels in a display, and more particularly, to a pixel driving circuit with a threshold voltage compensation circuit.

2. Discussion of Related Art

Generally, a display device displays an image through a plurality of pixels that are arranged in the form of a matrix, a honeycomb, etc. Each pixel is driven by a voltage or current writing type pixel driving circuit. In a display device using the current writing type pixel driving circuit, the brightness of the pixels depends on current.

FIG. 1 illustrates a conventional current writing type pixel driving circuit. When a gate line in the pixel driving circuit of FIG. 1 is at a high or active level, a Metal-Oxide-Semiconductor (MOS) circuit, i.e., the pixel driving circuit, is turned on, and current flows through the pixel driving circuit and a driving transistor M to drive an organic light emitting diode OLED.

While the conventional pixel driving circuit has a simple configuration, threshold voltage variation of the driving transistor M in each pixel cannot be eliminated, and consequently, display quality is diminished.

### SUMMARY OF THE INVENTION

To resolve mismatch between pixel driving transistors, which is a major problem of conventional pixel driving circuits, the present invention provides a pixel driving circuit in which a threshold voltage compensation circuit is added for compensating for variation in the threshold voltage of transistors driving pixels.

One aspect of the present invention provides a pixel driving circuit including: a diode-connected type first transistor through which input current data flows; a second transistor copying the current data flowing through the first transistor; a third transistor connected in series to the second transistor; a fourth transistor diode-connected between a power supply voltage terminal and the third transistor; and a driving transistor connected to the power supply voltage terminal, copying the current data flowing through the third transistor, and providing the data to a light emitting diode.

The pixel driving circuit may further comprise a gate selection transistor connected in series to the first transistor and allowing the input current data to pass through in response to a gate selection signal.

Another aspect of the present invention provides a pixel driving circuit including: a gate driver having a gate selection transistor allowing input current data to pass through in response to a gate selection signal, and a first transistor diode-connected to the gate selection transistor; and a plurality of pixel drivers sharing the gate driver, wherein each of the pixel drivers includes: a second transistor copying current flowing through the first transistor; a third transistor connected in series to the second transistor; a fourth transistor diode-connected between a power supply voltage terminal and the third transistor; and a driving transistor connected to the power supply voltage terminal, copying the current flowing through the third transistor, and providing the current to a light emitting diode.

The pixel driving circuit may further comprise a plurality of pixel selection transistors connected between the first transistor and the second transistor, and turned on in response to an output signal of a demultiplexer selecting each pixel, respectively.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a block diagram schematically illustrating a conventional pixel driving circuit;

FIG. 2 is a circuit diagram schematically illustrating a pixel driving circuit according to an exemplary embodiment of the present invention;

FIG. 3 is a circuit diagram illustrating the pixel driving circuit according to an exemplary embodiment of the present invention in detail; and

FIG. 4 is a circuit diagram illustrating a plurality of pixel driving circuits sharing a gate driver according to an exemplary embodiment of the present invention.

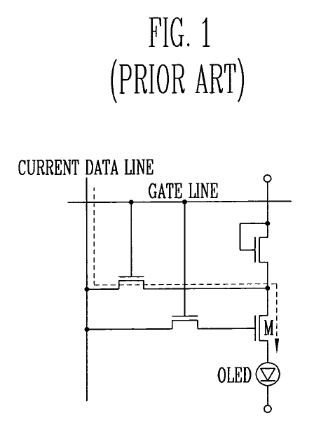

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are provided in order for this disclosure to be complete and enabling to those of ordinary skill in the art.

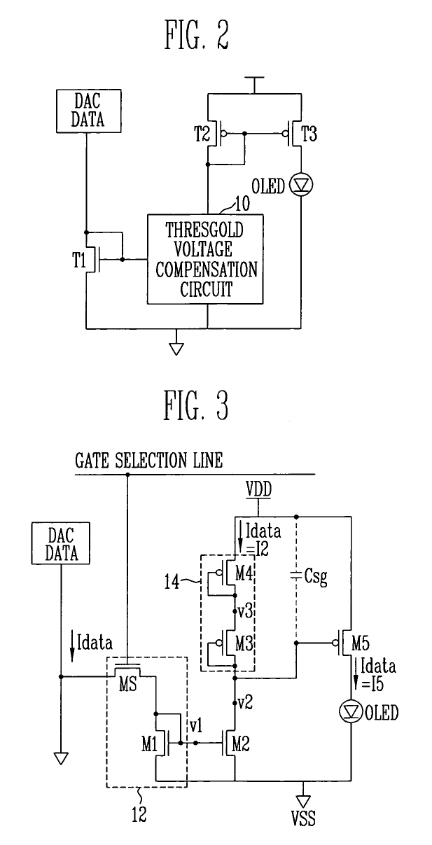

FIG. 2 is a circuit diagram schematically illustrating a pixel driving circuit according to an exemplary embodiment of the present invention.

The present invention suggests a method of compensating for mismatch of threshold voltage occurring in a current writing type pixel driving circuit by means of a threshold voltage compensation circuit. More specifically, as illustrated in FIG. 2, the present invention utilizes a current writing type pixel driving circuit so that a current data signal provided by a digital-to-analog converter (DAC) in a data driver of a display device, etc., i.e., DAC data, is input through the first transistor T1, current data corresponding to the DAC data is copied through a second transistor (not shown) connected to the first transistor T1 to form a current mirror, and then the current data that flows through a third transistor T2 is copied into a driving transistor T3 to thereby drive an organic light emitting diode OLED.

The threshold voltage of the driving transistor T3 for driving the pixels in the pixel driving circuit is slightly different in each pixel. Therefore, when the driving transistor T3 of the pixel driving circuit receives the current data and drives the pixels, a slight difference in the driving current is shown. To make up for this shortcoming in the structure of the pixel driving circuit, the present invention provides a structure in which the current data signal flows through the threshold voltage compensation circuit 10 first before it passes through a pixel driving circuit having the form of a current mirror.

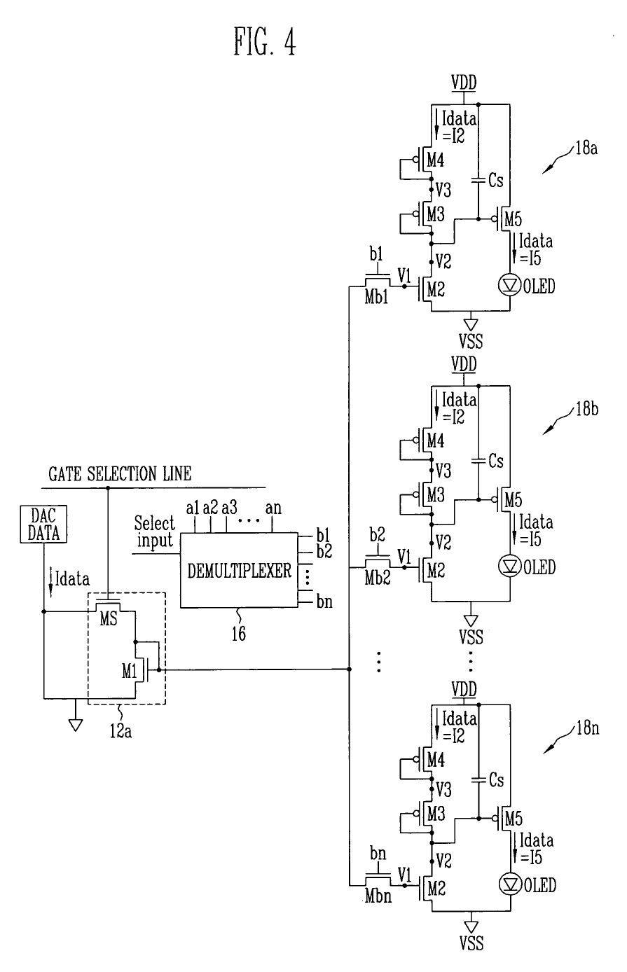

FIG. 3 is a circuit diagram illustrating a pixel driving circuit according to an exemplary embodiment of the present invention in detail.

As illustrated in FIG. 3, the pixel driving circuit according to an exemplary embodiment of the present invention includes a gate selection transistor MS turned on in response to a gate selection signal transferred through a gate selection line, and transferring DAC data, i.e., current data Idata, a first transistor M1 diode-connected to a source of the gate selection transistor MS, a second transistor M2 connected to the first transistor M1 to form a current mirror and copying the current data Idata that flows through the first transistor M1, a third transistor M3 connected in series with the second transistor M2 and connected to the driving transistor M5 to form the current mirror, a fourth transistor M4 diode-connected in series between a power supply voltage terminal VDD and the third transistor M3, and the driving transistor M5 connected between the power supply voltage terminal VDD and an organic light emitting diode OLED and providing the current data Idata to the organic light emitting diode OLED. A common node to which a predetermined voltage V1 is applied is connected to gates of the first and second transistors M1 and M2, and another power supply voltage terminal VSS having lower potential than ground or the power supply voltage terminal VDD is connected to one electrode of each of the first and second transistors M1 and M2, and the organic light emitting diode OLED.

The pixel driving circuit according to an exemplary embodiment of the present invention includes not only the threshold voltage compensation circuit 10 of the pixel driving circuit shown in FIG. 2, but also a gate selection transistor MS, and consists of a gate driver 12 and a pixel driver.

Also, in the pixel driving circuit according to an exemplary embodiment of the present invention, the gate selection transistor MS and the first transistor M1 select a pixel in response to the gate selection signal, and function as the gate driver 12 transferring the DAC data to the selected pixel. Further, the third transistor M3 connected to the driving transistor M5 directly driving the organic light emitting diode OLED to form the current mirror, and the fourth transistor M4 diode-connected between a source of the third transistor M3 and the power supply voltage terminal VDD, function as a threshold voltage compensator 14 compensating for variation in the threshold voltage of the driving transistor M5.

The driving transistor threshold voltage compensation process in the above-described pixel driving circuit is described below.

Generally, a current I flowing through a Metal-Oxide-Semiconductor (MOS) transistor is given by Equation 1:

$$I = K \frac{W}{L} {( \vert {V}_{GS} \vert - \vert {V}_{th} \vert )}^{2} , K = \frac{{μ}_{n} {C}_{OX}}{2} \qquad [ Equation 1 ]$$

Here, W denotes a channel width of the MOS transistor, L denotes a channel length of the MOS transistor, V_{GS} denotes a source-gate voltage of the MOS transistor, and Vₜₕ denotes a threshold voltage of the MOS transistor.

Therefore, the current data I₅ flowing through the driving transistor M5 in the pixel driving circuit of FIG. 3 is given by Equation 2:

$$\begin{matrix}{I}_{5} = K \frac{{W}_{5}}{{L}_{5}} {( \vert {V}_{GS} \vert - \vert {V}_{th 5} \vert )}^{2} \\ = K \frac{{W}_{5}}{{L}_{5}} {( {V}_{DD} - {V}_{2} - \vert {V}_{th 5} \vert )}^{2} \\ = K \frac{{W}_{5}}{{L}_{5}} {( {V}_{DD} - {V}_{3} + Δ V + \vert {V}_{th 3} \vert - \vert {V}_{th 5} \vert )}^{2} , \\ Δ V = {V}_{3} - {V}_{2} - \vert {V}_{th 3} \vert\end{matrix} \qquad [ Equation 2 ]$$

Here, K is a constant, W₅/L₅ denotes the size of the fifth transistor, V_{GS} denotes the gate-source voltage of the fifth transistor, Vₜₕ₅ denotes a threshold voltage of the fifth transistor M5, V_{DD} denotes a power supply voltage of a pixel, V₂ denotes a node voltage between the second and third transistors M2 and M3, V₃ denotes a node voltage between the third and fourth transistors M3 and M4, and Vₜₕ₃ denotes a threshold voltage of the third transistor M3.

Further, when ΔV of Equation 2 is expanded, Equation 3 is obtained:

$$\begin{matrix}Δ V = {V}_{3} - {V}_{2} - \vert {V}_{th 3} \vert \\ = \vert {V}_{GS\_M3} \vert - \vert {V}_{th 3} \vert \\ = \sqrt{\frac{{L}_{M 3} \times {I}_{data}}{{K}_{M 3} \times {W}_{M 3}}} \\ = \sqrt{\frac{{L}_{M 3}}{{K}_{M 3} \times {W}_{M 3}}} \times \sqrt{{I}_{data}}\end{matrix} \qquad [ Equation 3 ]$$

Here, K_{M3} is a constant, W_{M3}/L_{M3} denotes the size of the third transistor, and I_{data} denotes the current data flowing through the third transistor.

When Equations 2 and 3 are combined, Equation 4 yielding the current data I₅ flowing through the driving transistor is obtained:

$$\begin{matrix}{I}_{5} = {K}_{M 5} \frac{{W}_{M 5}}{{L}_{M 5}} {( \begin{matrix}{V}_{DD} - {V}_{3} + \vert {V}_{th 3} \vert - \vert {V}_{th 5} \vert + \\ \sqrt{\frac{{L}_{M 3}}{{K}_{M 3} \times {W}_{M 3}}} \times \sqrt{{I}_{data}}\end{matrix} )}^{2} \\ = {K}_{M 5} \frac{{W}_{M 5}}{{L}_{M 5}} {( \begin{matrix}\sqrt{\frac{{L}_{M 4}}{{K}_{M 4} \times {W}_{4}}} \times \sqrt{{I}_{data}} + \vert {V}_{th 3} \vert - \\ \vert {V}_{th 5} \vert + \sqrt{\frac{{L}_{M 3}}{{K}_{M 4} \times {W}_{3}}} \times \sqrt{{I}_{data}}\end{matrix} )}^{2} \\ ( \begin{matrix}<= {V}_{DD} - {V}_{3} = \sqrt{\frac{{L}_{M 4}}{{K}_{M 4} \times {W}_{M 4}}} \times \sqrt{{I}_{data}} , \\ \vert {V}_{th 3} \vert - \vert {V}_{th 5} \vert ≅ 0\end{matrix} ) \\ ≅ {K}_{M 5} \frac{{W}_{M 5}}{{L}_{M 5}} {( \begin{matrix}\sqrt{\frac{{L}_{M 4}}{{K}_{M 4} \times {W}_{M 4}}} \times \sqrt{{I}_{data}} + \\ \sqrt{\frac{{L}_{M 3}}{{K}_{M 3} \times {W}_{M 3}}} \times \sqrt{{I}_{data}}\end{matrix} )}^{2} \\ = {K}_{M 5} \frac{{W}_{M 5}}{{L}_{M 5}} {( \sqrt{\frac{{L}_{M 4}}{{K}_{M 4} \times {W}_{M 4}}} + \sqrt{\frac{{L}_{M 3}}{{K}_{M 3} \times {W}_{M 3}}} )}^{2} \times {I}_{data}\end{matrix} \qquad [ Equation 4 ]$$

Here, K_{M3}, K_{M4}, and K_{M5} are constants, W_{M3}/L_{M3}, W_{M4}/L_{M4}, and W_{M5}/L_{M5} are the sizes of the third, fourth, and driving transistors, and I_{data} denotes the current data flowing through the third transistor.

As shown in Equation 4, the current data I_{data} flowing through the driving transistor M5 has a form in which a threshold voltage part is offset. In other words, regardless of the threshold voltage of the driving transistor M5, the current data I_{data} may be provided to the organic light emitting diode OLED through the driving transistor M5. Therefore, non-uniform pixel brightness caused by variation in the threshold voltage of the driving transistor of each pixel can be eliminated.

For the purpose of efficient application of the threshold voltage compensation circuit, the threshold voltage and other physical specifications of the transistors M3 to M5 involved in compensating for variation in the threshold voltage of the driving transistor may be designed to be equal. For example, the sizes W/L of the transistors M3 to M5 may be substantially equal, and those transistors may be laid out adjacent to one another.

A source-gate parasitic capacitor (Csg) of the driving transistor M5 may be used as a capacitor that temporarily stores the current data I_{data} transferred through the pixel driving circuit and drives the driving transistor M5. Alternatively, a storage capacitor (Cs) may be used as the capacitor that temporarily stores the current data I_{data} transferred through the pixel driving circuit and drives the driving transistor M5, as shown in FIG. 4.

FIG. 4 is a circuit diagram illustrating a plurality of pixel driving circuits sharing a gate driver according to an exemplary embodiment of the present invention.

As illustrated in FIG. 4, the pixel driving circuit according to an exemplary embodiment of the present invention includes a gate selection transistor MS determining whether DAC data I_{data} should be transferred to pixel drivers of pixels 18a to 18n, a first transistor M1 diode-connected to the gate selection transistor MS, pixel selection transistors Mb1 to Mbn connected to the first transistor M1, a second transistor M2 coupled to the first transistor M1 to form a current mirror in each pixel driver, third and fourth transistors M3 and M4 compensating for variation in the threshold voltage and transferring the DAC data I_{data} to a driving transistor M5, the driving transistor M5 directly driving the pixels 18a to 18n, a storage capacitor Cs storing the DAC data I_{data} transferred to the driving transistor M5 and driving the driving transistor M5 during a predetermined time period, and a demultiplexer 16 generating output signals b1 to bn to select one of the pixel selection transistors Mb1 to Mbn.

The capacitor Cs may be replaced with a source-gate parasitic capacitor Csg of the driving transistor M5. The multiplexer 16 outputs one of the output signals b1 to bn based on a combination of bits that represents an input signal (Select input) and selection signals a1 to an. The output signals b1 to bn correspond to control signals for selectively transferring the current data signals to the pixels 18a to 18n, i.e., source selection signals of a display.

The pixel driving circuit according to an exemplary embodiment of the present invention further includes a demultiplexer and pixel selection transistors Mb1 to Mbn in the pixels based on the structure shown in FIG. 4 so that each pixel driver shares a gate driver 12a.

The structure of sharing the gate driver 12a in the pixel driving circuit according to an exemplary embodiment of the present invention, in which the diode-connected first transistor M1 is shared by each pixel, may solve the problem of first transistor mismatch due to transistors fabricated with slightly different properties. In other words, when the first transistor M1 is shared, variation in the threshold voltage of the first transistor M1 of each pixel may be compensated for.

The present invention reduces current nonlinearity in the driving transistor caused by mismatch of the threshold voltage that generally occurs in the pixel driving circuit.

As described above, the present invention can solve problems stemming from non-uniformity of the threshold voltage of a pixel driving transistor in pixels of a display device by adding a threshold voltage compensation circuit into the pixel driving circuit. Also, using the function of a demultiplexer to share the transistor can reduce the number of transistors and reduce non-uniformity of the transistors between adjacent pixels.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A pixel driving circuit, comprising:
a diode-connected type first transistor through which input current data flows;
a second transistor copying the current data flowing through the first transistor;
a third transistor connected in series to the second transistor;
a fourth transistor diode-connected between a power supply voltage terminal and the third transistor; and
a driving transistor connected to the power supply voltage terminal, copying the current data flowing through the third transistor, and providing the data to a light emitting diode.

2. The pixel driving circuit according to claim 1, further comprising a gate selection transistor connected in series to the first transistor and allowing the input current data to pass through in response to a gate selection signal.

3. A pixel driving circuit, comprising:
a gate driver having a gate selection transistor allowing input current data to pass through in response to a gate selection signal, and a first transistor diode-connected to the gate selection transistor; and
a plurality of pixel drivers sharing the gate driver, wherein each of the pixel drivers includes:
a second transistor copying current flowing through the first transistor;
a third transistor connected in series to the second transistor;
a fourth transistor diode-connected between a power supply voltage terminal and the third transistor; and
a driving transistor connected to the power supply voltage terminal, copying the current flowing through the third transistor, and providing the current to a light emitting diode.

4. The pixel driving circuit according to claim 3, further comprising a plurality of pixel selection transistors connected between the first transistor and the second transistor, and turned on in response to an output signal of a demultiplexer selecting each pixel, respectively.

5. The pixel driving circuit according to claim 1, wherein the third to fifth transistors have the same design value.

6. The pixel driving circuit according to claim 1, further comprising a capacitor or a parasitic capacitor connected between a source and a gate of the driving transistor.
